(19) United States
(12) Patent Application Publication
(10) Pub. No.: US 2014/0326813 A1
(43) Pub. Date: Nov. 6, 2014

(54) CHOPPING-GRINDING MILL

(71) Applicant: MOLINARI S.R.L., Lenna (IT)

(72) Inventor: Giovanni Lorenzo Gervasoni, Lenna (IT)

(73) Assignee: MOLINARI S.R.L., Lenna (IT)

(21) Appl. No.: 14/357,047

(22) PCT Filed: Nov. 9, 2012
(86) PCT No.: PCT/IB2012/056304

§ 371 Date: May 8, 2014

(30) Foreign Application Priority Data
Nov. 9, 2011 (IT) MI2011A002029
May 7, 2012 (IT) MI2012A000762

(51) Int. Cl. B02C 7/12; B02C 25/00; B02C 7/08

(52) U.S. Cl. CPC B02C 7/12; B02C 7/08; B02C 25/00
USPC 241/34; 241/257.1; 241/245

(57) ABSTRACT

A chopping-grinding mill for used objects and other waste materials includes a base, on which a disc-shaped vertical-axis rotor (2) is rotatably mounted, the rotor (2) having a plurality of cutting blades (5, 6) fixed to its upper surface. A disc-shaped coaxial stator (3) is associated with the rotor (2) and carries a plurality of cutting blades (II, 12) fixed to its lower surface. The stator (3) is fixed at an adjustable distance above the rotor (2), which together define a grinding chamber. Primary cutting blades (5, II) extend from the centre to the periphery of the rotor (2) and stator (3) and secondary cutting blades (6, 12) extend only in correspondence of a peripheral crown of the rotor (2) and of the stator (3), while a feeding window (10) of the material to be ground is provided in the stator (3), in the area inside to the peripheral crown.

### FIELD OF THE INVENTION

The present invention relates to a mill for chopping and chopping-grinding different materials, and in particular to a mill of this kind apt to turn into small granules, in a single step, raw materials, residual materials, recyclable materials and, more in general, whole objects or large-sized split objects comprising multiple assembled materials. The granules obtained downstream of the mill are suited to be directly classified and separated for use in the market of secondary raw materials. The invention relates also to a feeder specifically designed for the regular feeding of tyres to said mill.

The chopping-grinding mill of the invention is described in the following with special reference to the use thereof in chopping and grinding worn tyres, but such a reference must be understood solely as an example of a preferred field of application, since the chopping-grinding mill according to the invention is also suited for turning into granules, and hence for obtaining a simultaneous volume reduction thereof, the most disparate materials such as, by way of a non-exhaustive example, wooden and plastic objects, skins, plastic films, paper, rubber; urban waste such as mattresses and other bulky waste; industrial waste, such as bumpers, tanks, batteries, sprues and packages of any kind and nature; hospital waste; in general, any solid waste material which has ended its useful life cycle and the size of which is such as to be able to be fed to the mill.

### STATE OF THE PRIOR ART

The chopping/grinding operations of motor vehicle tyres currently take place in large, partly outdoor plants, which provide, after a possible preliminary bead removal operation (not required for car tyres), to send the individual tyres, through a conveyor belt, to a primary chopper where cutting of the tyres into large pieces of a size of about 150-300 mm is performed.

The material thus obtained is then made to go onto two further conveyor belts to feed corresponding secondary choppers arranged in series, which have the function of progressively reducing the rubber parts to a size below 20 mm (chips). Simultaneously to this operation, or immediately after the same, the wires normally embedded in the tyre rubber structure are removed and separated from the rubber parts.

The mixed material thus obtained is then fed to vibrating plates associated with magnetic separators, thus accomplishing the separation between the iron material, which is removed, and the rubber chips.

Such rubber chips, thus devoid of the iron, are finally sent for a fine grinding step, which is carried out in a suitable refining mill, where the rubber is reduced to a commercial granular shape of an average size of about 4 mm. At this point the work cycle is ended and the rubber granule is taken from the plant and marketed for the most disparate uses, both directly and following further, extremely fine grinding in suitable pulverising machines from which a rubber dust comes out having a size of a few tens of millimetre.

US 2007/0029423 and DE 28147878 disclose pulverising machines of this kind which have a vertical axis, central feeding and opposite grinding discs. The machine described in the US patent, for example, is suitable to treat rubber chips or granules of a size ranging between 10 and 15 mm to reduce them to a size ranging between 0.2 and 0.4 mm.

As can be easily understood from the albeit concise above description, the known plants of this type, in addition to having a high purchase cost of the different pieces of equipment they consist of, also require large space occupation, both due to the bulky equipment and to the corresponding feeding and transfer conveyor belts, and to the storage of the tyres waiting to be processed. These are hence plants which have a particularly high overall installation cost, to which high maintenance and running costs are furthermore to be added, determined in particular also by the high overall power of the installed equipment. In order to allow an economically advantageous management of such plants it is hence essential for them to act as collection centres of used tyres coming from the workshops—large and small ones, for tyre repair, maintenance and replacement—of a very wide area.

An additional disadvantage of these plants is hence given by the fact that the used tyres must be transferred from the workshops where the replacement thereof occurs to the above-said collection and processing centre, which implies high additional transport costs, so much higher due to the fact that the hollow structure of the tyres implies the occupation of a much higher transport volume than would be necessary according to the weight thereof.

### Problem and Solution

The problem at the basis of the invention is hence to overcome such drawbacks, and in particular to dramatically reduce the size of conventional grinding plants, as well as the relative running costs, hence allowing the installation and the direct use thereof at any tyre repair/replacement workshop, whether small or large, thus reducing to zero also transport costs to collection and processing centres.

A further object of the present invention is to provide a feeder device for a chopping-grinding mill of the type described above, which allows to accomplish a continuous feeding of the mill starting from a conventional loading system of the feeder, for example of the type freely falling off a conveyor belt, maintaining a controlled pressure of the objects to be processed against the cutting blades of the mill, regardless of the shape of said objects and of the location thereof.

These objects are achieved through the chopping-grinding mill having the features defined in claim 1, through which it is possible to obtain, with a single machine, the direct turning into granules of whole tyres having a final granule size perfectly suitable for the subsequent classification and refinement operations. The dependent claims describe preferred additional features of the invention.

### BRIEF DESCRIPTION OF THE DRAWINGS

Further features and advantages of the waste chopping-grinding mill of the invention will in any case be more evident from the following detailed description of a preferred embodiment of the same, given purely as a non-limiting example and illustrated in the attached drawings, wherein:

FIG. 1 is a perspective overall view of a chopping-grinding mill according to the invention;

FIG. 2 is a top plan view of the same chopping-grinding mill;

FIG. 3 is a top plan view similar to that of FIG. 2, from which the mill stator has been removed to show the underlying rotor;

FIG. 4 is a plan view from below of the mill stator;

FIG. 5 is an axial cross-section view of the mill of FIG. 1;

FIG. 6 is an elevation side view of a feeder for the chopping-grinding mill of FIG. 1;

FIG. 7 is a top plan view of the feeder of FIG. 6;

FIG. 8 is a cross-section view of the feeder, according to the line VIII-VIII of FIG. 6; and

FIG. 9 is an overall perspective view of the feeder for the chopping-grinding mill according to the invention.

### DETAILED DESCRIPTION OF A PREFERRED EMBODIMENT

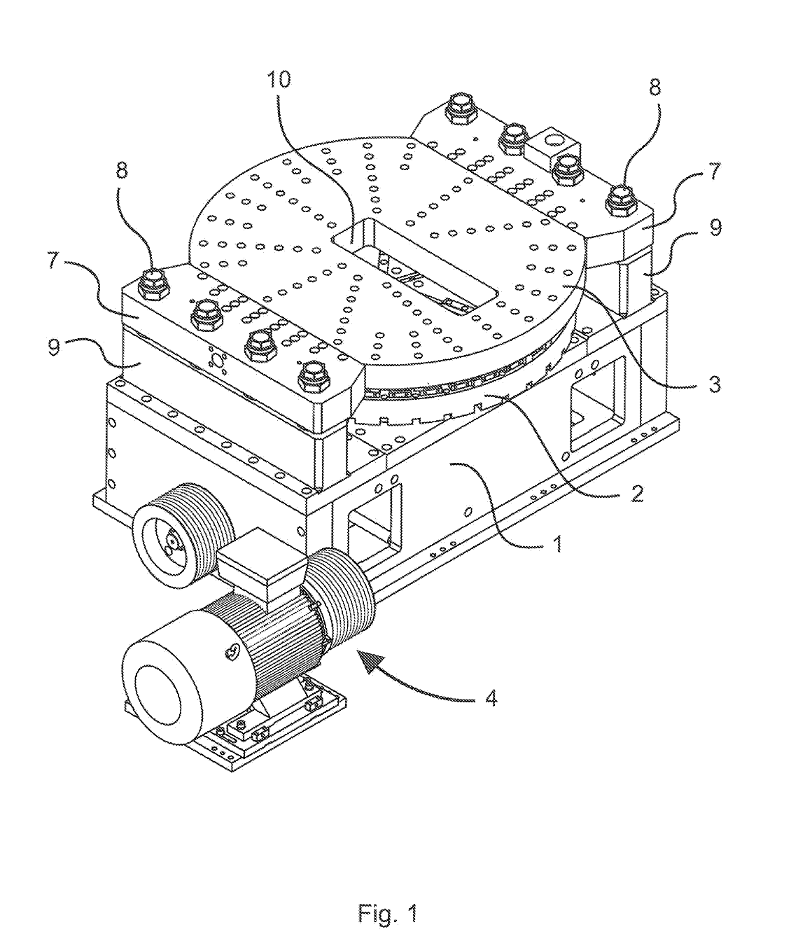

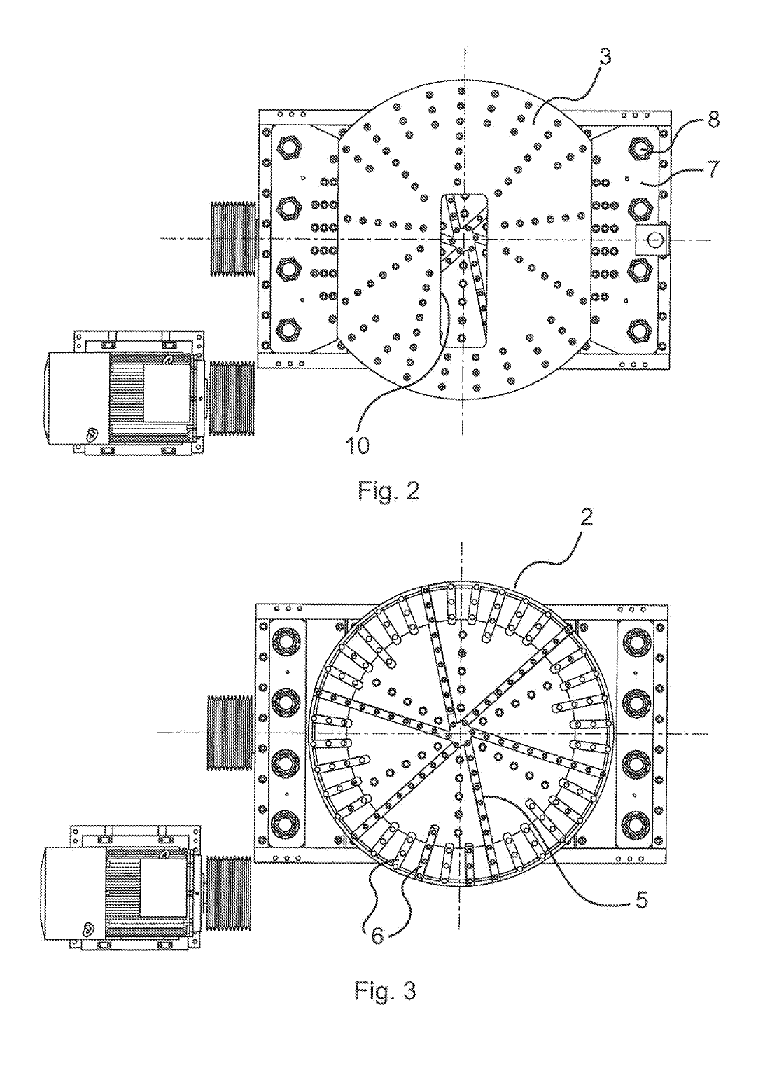

As schematically shown in FIG. 1, the chopping-grinding mill according to the invention is a vertical-axis mill essentially comprising: a sturdy base 1, a lower rotor 2, an upper stator 3 and a motor 4, which drives rotor 2 into rotation.

Base 1 is manufactured through machining on CNC-numeric-control machine tools, levelled and securely fixed to the ground. It is dimensionally oversized to obtain maximum machine rigidity.

On base 1 two cutting discs 2, 3 are mounted; lower disc 2 is mounted rotating on base 1 and is hence called in short “rotor”. Upper disc 3 is instead mounted fixed on base 1 and is called in short “stator”.

Rotor 2 is a large-diameter disc made of ultrasound-treated carbon steel machined through chip removal by CMC machine tools. Rotor 2 has a large thickness, and this allows it, in addition to the cutting action, to also perform a flywheel function, so as to obtains an even rotary motion during the cutting action. The parts of rotor 2 which are exposed to the material to be ground are coated with tungsten carbide, so as to obtain a surface hardness above 1300 HV and hence make rotor 2 more resistant to abrasion and to corrosion.

Rotor 2 is supported by a preloaded bearing for axial thrusts and by a precision bearing for radial and axial thrusts. Lubrication is guaranteed by a microprocessor-controlled automatic multipoint system. The bearing temperature is constantly monitored by heat probes. A double external labyrinth guarantees bearing cleanliness.

The rotor receives rotary motion from a motor 4, through a statically-balanced, compact elastic joint (not shown in detail) suitable for high work torques, provided with a vibration dampening system.

As shown in FIG. 3, primary cutting blades 5 and secondary cutting blades 6 are fastened, with a radial or subradial attitude, to the upper surface of rotor 2. Seats for the blades 5 and 6 are formed on the upper face of rotor 2, while on the lower face of such rotor smooth cylindrical through-seats are formed for housing threaded bushes (not shown) and of corresponding screws which allow the fastening of said blades without threaded holes being formed in the rotor, thus avoiding dangerous trigger points of possible fatigue breaks.

Primary blades 5 are of a length substantially equal to the radius of rotor 2, i.e. they develop from the outer circumference of the same to the centre, or more exactly to a position tangential to the axial pin of rotor 2. Said blades are evenly spaced out from one another by an angle of 30°-90°, preferably of 45°-75° and even more preferably of about 60°, so as to have wide room between one another which allow to introduce the material to be ground, as will be clearer in the following.

Secondary blades 6, themselves with a radial or subradial arrangement, are instead of a length far shorter than the radius of rotor 2 and are positioned only in a relatively limited, peripheral crown of the rotor, for the purpose better described in the following. Also secondary blades 6 are evenly spaced out, both from one another and with respect to blades 5, by an angle of 5°-15° and preferably of about 10°. In the currently preferred embodiment, between each pair of primary blades 5 five secondary blades 6 are hence arranged, the one in a central position potentially being able to have a slightly longer radial length than the remaining ones. From what has been set forth above and from the examination of the drawings it should finally be evident that the outer portion of primary blades 5 which is positioned within said peripheral crown of rotor 2 performs the same function as secondary blades 6.

Above rotor 2 stator 3 is mounted; itself consisting of a large-diameter disc, made of ultrasound-treated carbon steel and machined through chip removal by CNC machine tools. Also stator 3 is oversized in order to absorb undamaged radial and axial impacts. As for rotor 2, the parts of stator 3 exposed to the material to be ground are coated with tungsten carbide.

Stator 3 is opposite to rotor 2 and it is maintained perfectly coaxial and parallel thereto. Stator 3 is provided with two opposite trapezoidal appendixes 7, by means of which it is fastened, through adjusting screws 8, to corresponding posts 9 of base 1. Adjusting screws 8 guarantee an adequate mounting stiffness while loading the shearing stresses on the base 1. Adjusting screws 8 act on an equal number of conical-seat bushes (not shown) formed in posts 9, thus allowing to micrometrically adjust the distance between rotor and stator to the desired value, depending on the material being processed and on the desired final granulometry.

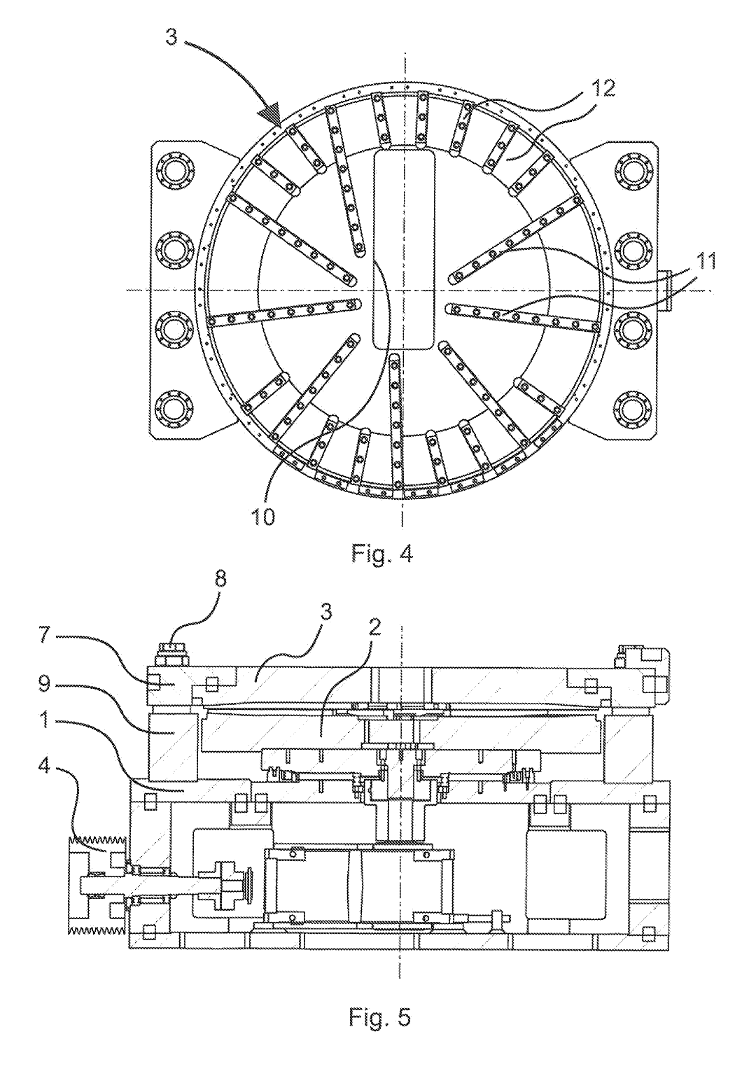

Suitably offset seats for housing primary and secondary cutting blades 11 and 12, respectively, are formed on the lower portion of stator 3; similarly to what has been described above for rotor 2, primary blades 11 extend in a radial or subradial direction as far as near the centre of the stator 3, ending in correspondence of a feeding window 10, while secondary blades 12 are positioned within a peripheral circular crown corresponding to the above-described one wherein the secondary blades 6 of rotor 2 are positioned. Blades 11 and 12 are fixed through through-screws and threaded bushes, to avoid the presence of threaded holes within the disc which forms stator 3, in a fully similar way to what has been shown above for the blades 5 and 6 of rotor 2, and also the angular arrangement thereof meets the same parameters described for the blades of rotor 2, compatibly with the fact that the presence of window 10 causes some unevenness in such arrangement as exemplarily shown in the drawing of FIG. 4 where, for the sake of illustration simplicity, not all secondary blades 12 have been shown. Even in the case of stator 3, it is evident that the outer portion of primary blades 11, which is positioned within said peripheral crown of stator 3, performs the same function as secondary blades 12.

As already mentioned above, in the thickness of stator 3 a window 10 is formed, having a substantially rectangular shape, through which the objects to be ground as in particular tyres (not shown), are introduced, one at a time, to be thus brought in contact with the primary blades 5 of rotor 2. As a matter of fact, window 10 extends onto stator 3 in a diametrical direction exclusively in the area in which the main blades 5 of rotor 2 operate, hence without affecting the area occupied by secondary blades 6.

As far as the driving of the mill of the invention is concerned, motor 4 can indifferently consist of:
an orthogonal-axes reduction unit with forced lubrication at a temperature controlled by a heat exchanger. This reduction unit can be operated by an electric or hydraulic motor;
a direct hydraulic motor, operated by a suitably-sized hydraulic central unit;
a Torque motor.

Preferably, the chopping-grinding mill according to the present invention is furthermore provided with a system to make stator 3 easily and quickly interchangeable. This system is used to remove stator 3 from base 1 and move it away from the machine, so as to make both the change of blades 5, 6 of rotor 2 and the change of fixed blades 11, 12 associated with the stator 3 easier and quicker, since it is possible to access all these blades much more easily, with no interference whatsoever.

The system for quick stator 3 change consists of an additional frame fixed to base 1, whereon a carriage supported by recirculating-ball sliding blocks and operated by a toothed belt system slides. To said carriage mounted on sliding blocks two oleodynamic actuators are fastened which can cause the lifting of stator 3, after having loosened the adjusting screws 8; after the stator 3 has been lifted, the carriage is moved into a side position to allow blade replacement.

In case one wanted to speed up further the blade maintenance operation, a second stator 3 already provided with sharp blades and interchangeable with the first one may be used; in this case the only machine idle time is reduced to that of the blade change of rotor 2, during which operation the replacement of the stator 3 on the carriage with sliding blocks with the sharp-blade spare stator may also be performed.

During the operation of the chopping-grinding mill of the present invention, in case different, small-sized materials are being processed, it is possible to provide on the upper portion of the mill a loading hopper, which allows to directly convey the material into the grinding chamber, through window 10. The hopper is fixed to the upper portion of the base 1, hence without causing any obstacle to the removal manoeuvre of stator 3 and/or to the blade replacement operation.

In case bulky objects are to be ground, as indeed in the case of tyres, these—as already stated—are introduced one at a time into window 10; as a matter of fact, it is sufficient to rest the tyre inside window 10, maintaining a certain pressure on the same so that it rests on the surface of rotor 2 and it is gradually and automatically “sliced” by the action of blades 5, with no need for operator intervention, due to the presence of wide empty sectors between two blades 5 adjacent on rotor 2 which allow the progressive lowering of the tyre being processed and the removal of material from the same through successive cuts.

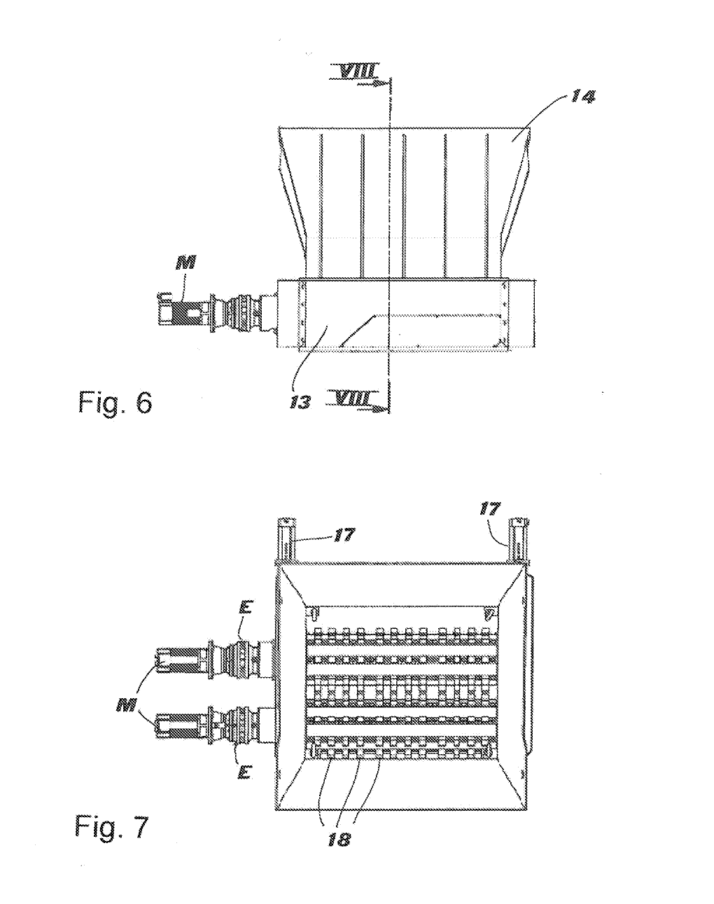

The introduction of the tyres into window 10 can be performed both manually and with a suitable automatic feeder, which is part of the present invention, which correctly orientates the tyres and feeds them to said window 10. Such feeder will be described in detail in the following with reference to FIGS. 6-9.

The structure of the feeder for the chopping-grinding mill according to the present invention comprises a sturdy rectangular frame 13, on which a wide loading hopper 14 is fastened. Frame 13 is of a size proportioned to the chopping-grinding mill to which it is joined and, in particular, it is such as to fully cover the feeding window 10 of the same. Frame 13 comprises fastening means (not shown) which allow to anchor it securely to the loading plane of the chopping-grinding mill.

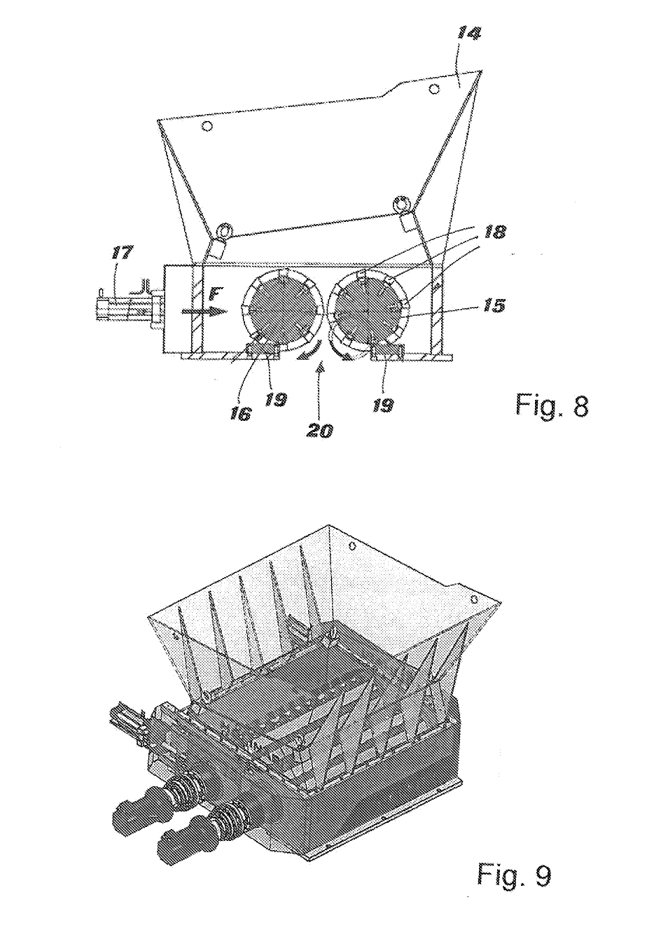

Within frame 13 two counter-rotating, parallel-axes rollers 15, 16 are pivoted, the arrangement of which is clearly shown in the cross-section drawing of FIG. 8, said rollers being driven into movement by respective electric motors M, each one provided with an epicycloidal reduction unit, arranged outside frame 13. The rotation axis of roller 15 is fixed with respect to frame 13, while the axis of rotation of roller 16 is movable in the direction of arrow F—i.e. in a direction perpendicular to said axes—under the thrust action of a pair of pneumatic actuators 17 which act on the end supports of roller 16, thus holding it pushed towards roller 15 with a constant and adjustable force. This particular construction of the pair of rollers 15 and 16 allows to have a feeding system automatically and elastically adaptable to any size of the object to be ground and, in particular, of a tyre. A preferred operating pressure of actuators 17 is 2 bar.

The power supply of motors M is preferably adjusted depending on the power consumption by the main motor 4 of the chopping-grinding mill on which the feeder is mounted, with the purpose of maintaining the power consumption of said main motor 4 as far as possible constant, around the maximum efficiency value. In particular, the control of motors M is such that the rotation speed of motors M is brought to its maximum value when the power consumption of said main motor 4 of the chopping-grinding mill is below its optimal value and gradually decreases as such power consumption increases, until it stops when the power consumption becomes equal to or higher than the set optimal value, allowing the mill to deal with any work overload.

A further control is set on the power consumption of the motors M for the rotation of rollers 15, 16, to address any jam situations of the fed material. As a matter of fact, when said power consumption exceeds the set value, motors M invert the running direction of rollers 15, 16 for a programmable time and then resume normal running. If, after a certain number of forward/backward cycles the power consumption does not decrease under the set reference parameter, the feeder stops and sends an alarm signal to the operator.

Due to these controls, the feeder of the present invention can hence work in a fully automatic way, hence with no need for an operator who continuously supervises the feeder, a discontinuous presence being sufficient to solve any borderline situations which may have determined the stopping of the machine.

In order to facilitate the gripping and dragging of some special objects to be ground, and especially in order to prevent the same from being captured too quickly by the blades of the chopping-grinding mill, rollers 15, 16 can be provided with toothed inserts 18, suitably arranged along the surfaces of one or both rollers 15, 16 and protruding from said surfaces. The task of inserts 18 is only to accompany the material to be ground towards the mill and to adjust the feeding speed, reducing it in case the material is even partly dragged, instead of being cut, by the blades of the chopping-grinding mill; for this purpose it is suitable for a remarkable clearance, for example of a few centimetres, to always remain between adjacent inserts of the two opposite rollers 15 and 16.

In order to prevent inserts 18 from being able to determine an undesired dragging of the material around rollers 15, 16, rejection bars 19 are finally provided at the edges of the exit window 20 of the feeder; suitable grooves formed in said rejection bars allow only inserts 18 to go through the same. Thereby, the entire material fed by rollers 15 and 16 is sent to exit window 20, which corresponds exactly to the feeding window 10 of the underlying chopping-grinding mill.

Regardless of the above-described manual or automatic loading mode, the material introduced—once it has arrived at the grinding chamber formed between stator 3 and rotor 2—goes through three annular cutting areas, arranged in the proximity of the central pin, in an intermediate position and in the peripheral crown of the grinding chamber of the mill, respectively:
a) in the first central annular cutting area the entry cut of the material and the first rough-grinding of the same occur. Due to the radial arrangement of the blades, the rough material or the whole or large-sized split objects are firstly sliced and then rough-ground, exploiting the greater cutting forces connected with the lower moving speed of the blades in the proximity of the centre of the mill; the material thus sliced and rough-ground is then simultaneously conveyed—by means of the centrifugal forces acting on the same—towards the intermediate portion of the grinding chamber;
b) in such second annular cutting area, due to the increasing speed of primary cutting blades 5 and 11, the material is further reduced in size and then, still as an effect of the centrifugal forces acting on the same, it is progressively moved towards a third cutting area corresponding to the outer crown of the grinding chamber, in particular precisely that area characterised by the presence of secondary cutting blades 6 and 12;
c) in the above-said third annular cutting area, the material is finally minced until it reaches the desired final granulometry, defined by the shape and by the mutual positioning of blades 6 and 12 arranged in correspondence of said outer crown of rotor 2 and of stator 3. As a matter of fact, the function of said secondary blades is to define the exit section of the material and hence the granulometry of the final product. Blades 6 and 12 are made of wear-resistant steel and have a particular geometry which can be modified according to the type of material processed and to the desired requirements of the final granular product.

The granular material projected outside the mill finally falls onto conveyor belts which will convey it to the collection point from where it will be sent for reuse, following suitable conventional iron-removal procedures.

Compared to known plants, the chopping-grinding mill according to the invention has the extraordinary advantage of concentrating in a single machine, of an extremely small size and cost, all the functions carried out in known plants by various large-sized equipment and by the relative transport systems. This hence allows to install the chopping-grinding mill of the invention directly in large and small workshops for the maintenance, repair and replacement of motor vehicle tyres, thus fully reaching the first object of the invention.

As it should be clear from the preceding description, also the feeder of the present invention has fully reached the set object. As a matter of fact, the objects loaded in bulk into hopper 14—normally through a loading conveyor belt—are progressively captured by rollers 15, 16, which adapt elastically to the different shapes of the objects, and sent to the underlying grinding chamber, maintaining an adequate pressure against the cutting blades and simultaneously imparting an adjusting action of the feeding speed which avoids overloads and jams of the chopping-grinding mill. All this with no need for any intervention by the operator, due to the electronic controls of motors M based on the values of power consumption of the main cutting motor 4 of the chopping-grinding mill and of the same motors M.

From the dramatic concentration of functions and reduction in size of known grinding plants in a single small-sized machine derive also the further advantages of:
1) smaller power ratings installed
The power ratings installed to process 4 t of tyres until obtaining granules of a size equal to 4 mm with the method of the traditional prior art are essentially those relating to:
   two secondary grinders with a power of 150 kW (75 kW each);
   a refining mill with a power of 160 kW; while according to the invention it is solely necessary:
   a single chopping-grinding mill with a power of 200 kW, hence with a reduction of installed power rating of over 30%.
2) Shorter machine idle time for maintenance

In known-type plants the blade replacement in grinders and granulators requires a machine idle time of about 2.5 days. On the contrary, in the mill according to the invention the blade replacement of rotor 2 implies a machine idle time of only about 3 hours. As a matter of fact, the blade replacement time of stator 3 must not be calculated taking into account the above-illustrated opportunity—through the use of a ready replacement stator with new, already mounted blades—of replacing the relative blades while the mill is operating.
3) Less bulk

The mill according to the invention occupies an area of about 6 m² while the area occupied by a plant comprising two secondary grinders and a refining mill, with relative loading belts, characteristic of a prior-art plant, may reach over 1,000 m². The space reduction obtained by the chopping-grinding mill of the invention is hence dramatic.

However, it is understood that the invention must not be considered limited to the particular arrangement illustrated above, which represents only an exemplifying embodiment thereof, but that a number of variants are possible, all within the reach of a person skilled in the field, without departing from the scope of the invention, which is defined exclusively by the following claims.

1. Chopping-grinding mill for used objects and other waste materials, in particular for motor vehicle tyres, of the type comprising, in a single compact work unit, a base (1), whereon a vertical-axis rotor (2) is rotatably mounted, said rotor (2) having the shape of a disc carrying a plurality of cutting blades (5, 6) fixed to the upper surface thereof, to said rotor (2) a coaxial stator (3) being associated, in turn in the shape of a disc carrying a plurality of cutting blades (11, 12) fixed to the lower surface thereof, said stator (3) being mounted in a fixed position above the rotor (2) and at an adjustable distance therefrom so as to define therewith a grinding chamber of the material to be processed wherein said blades (5, 6; 11, 12) comprise primary blades (5, 11) which extend from the centre to the periphery of said rotor (2) and stator (3) and secondary blades (6, 12) which extend only in a peripheral crown of said rotor (2) and stator (3) and in that in said stator (3) a feeding window (10) of the material to be processed is formed which opens out, at least partly, on a grinding chamber area where exclusively said primary blades (5, 11) operate.

2. Chopping-grinding mill as claimed in claim 1, wherein the disc forming said rotor (2) has a sufficiently large thickness to impart to said disc, in addition to the support function of the cutting blades (5, 6) also the flywheel function.

3. Chopping-grinding mill as claimed in claim 1, wherein said cutting blades (5, 6; 11, 12) are arranged in a radial or subradial direction with respect to said rotor (2) and stator (3).

4. Chopping-grinding mill as claimed in claim 3, wherein said primary blades (5, 11) are angularly spaced out from each other by 30°-90°, preferably by 45°-75° and even more preferably by about 60° and said secondary blades (6, 12) are spaced out from each other and from said primary blades (5, 11) by 5°-15° and preferably by about 10°.

5. Chopping-grinding mill as claimed in claim 4, wherein the secondary blades (6, 12) being at a greater circumferential distance from the primary blades (5, 11) are of a greater length than the remaining ones.

6. Chopping-grinding mill as claimed in claim 1, wherein said grinding chamber comprises three annular grinding areas, which are subsequently crossed by the material to be ground, due to the action of the centrifugal forces acting on said material, with progressive reduction of the granulometry of the same.

7. Chopping-grinding mill as claimed in claim 6, wherein the final granulometry of the granular material is determined by the number, shape and arrangement of the secondary blades (6,12) and of the end of the primary blades (5, 11) arranged there between.

8. Chopping-grinding mill as claimed in claim 1, wherein said rotor (2) and stator (3) are made of steel and the inner surface of the grinding chamber formed between the same and the surfaces of the primary and secondary blades (5, 6; 11, 12) have a hardening surface coating, such as a layer of tungsten carbide.

9. Automatic feeder for a chopping-grinding mill of used objects and other waste materials, in particular motor vehicle tyre, as claimed in claim 1, wherein it comprises a pair of parallel-axes, side-by-side rollers (15, 16), mounted on a frame (13) made integral with said mill in correspondence of said feeding window (10), and in that the rotation axis of one of said rollers (16) is elastically movable with respect to the rotation axis of the other one of said rollers (15), in a direction (F) perpendicular to said axes.

10. Automatic feeder for a chopping-grinding mill as claimed in claim 9, wherein said movable rotation axis of one of said rollers (16) is under an elastic thrust force supplied by a pair of pneumatic actuators (17) acting on the opposite supports of the rotation axis of said roller (16).

11. Automatic feeder for a chopping-grinding mill as claimed in claim 10, wherein the operating pressure of said pneumatic actuators is equal to 2 bar.

12. Automatic feeder for a chopping-grinding mill as claimed in claim 9, wherein said rollers (15, 16) are moved by respective motors (M), the rotation speed of which is adjusted depending on the power consumption of the main motor (4) of the chopping-grinding mill whereon said feeder is mounted, so as to gradually reduce said rotation speed as said power consumption comes closer to a preset threshold value, and to stop when said value is reached or exceeded.

13. Automatic feeder for a chopping-grinding mill as claimed in claim 12, wherein the rotation direction of said actuation motors (M) is inverted for a preset period of time when the electric power consumption of said motors (M) exceeds a preset threshold value.

14. Automatic feeder for a chopping-grinding mill as claimed in claim 9, wherein inserts (18) projecting from the surface of said rollers, for accompanying/retaining the material fed, are further provided.

15. Automatic feeder for a chopping-grinding mill as claimed in claim 14, wherein rejection bars (19) are further provided in correspondence of the exit window (20) of the feeder, suitable grooves formed in said rejection bars allowing said inserts (18) to go through the same.
